(19) United States
(12) Patent Application Publication
(10) Pub. No.: US 2026/0050242 A1
(43) Pub. Date: Feb. 19, 2026

(54) Remote Ai Monitoring And Control Unit With Multi-Protocol Integration, Advanced Ai Capabilities, And Enhanced Security

(71) Applicant: Xinxin Shan, Surrey (CA)

(72) Inventor: Xinxin Shan, Surrey (CA)

(73) Assignee: LED Smart Inc, Surrey, BC (CA)

(21) Appl. No.: 18/805,404

(22) Filed: Aug. 14, 2024

(51) Int. Cl. G05B 13/02

(52) U.S. Cl. CPC G05B 13/0265

(57) ABSTRACT

The present invention relates to a remote AI monitoring and control unit designed for industrial automation. This unit integrates multiple communication protocols, advanced artificial intelligence (AI) capabilities, and enhanced security features to autonomously or semi-autonomously monitor and control industrial processes. The unit supports a wide range of communication protocols, including MQTT, USART, CAN bus, I2C, SPI, Modbus, Profibus, DeviceNet, EtherNet/IP, CANopen, PROFINET, BACnet, DNP3, and HART, ensuring seamless interoperability with various industrial devices. It features adaptive communication, predictive maintenance, anomaly detection, and edge AI processing. Enhanced security is achieved through blockchain integration, AI-based threat detection, and multi-layered encryption. The unit also incorporates energy-efficient operation with energy harvesting and AI-optimized power management. An augmented reality (AR) interface provides real-time data visualization and remote assistance. The modular and scalable design allows for easy customization and expansion, while a user-friendly software interface offers customizable dashboards and AI-driven insights.

### CROSS-REFERENCE TO RELATED APPLICATIONS

US Patent Documents
6549937 B1 4/2003 Auerbach

### OTHER PUBLICATION

P Klein et al. “Generation of Complex Data for AI-based Predictive Maintenance Research with a Physical Factory Model”, —ICINCO (1), 2019—scitepress.org
Sonia Kotel et al. “A Blockchain-based approach for secure IoT”, Procedia Computer Science 225 (2023) 3876-3886, ScienceDirect.com
Teodora Sanislav et al. “Energy Harvesting Techniques for Internet of Things (IoT)”, March 2021, IEEE Access PP(99):1-1, PP(99):1-1
Lorenzo Damiani et al. “Augmented and virtual reality applications in industrial systems: A qualitative review towards the industry 4.0 era”, IFAC PapersOnLine 51-11 (2018) 624-630, ScienceDirect.com
Luis M. Contreras et al. “Modular architecture providing convergent and ubiquitous intelligent connectivity for networks beyond 2030”, ITU Journal on Future and Evolving Technologies, Volume 3, Issue 3, December 2022

### BACKGROUND OF THE INVENTION

In industrial automation, there is a growing need for systems that can integrate various communication protocols to ensure interoperability among devices from different manufacturers. Additionally, incorporating AI into these systems enhances their ability to perform predictive maintenance, anomaly detection, and real-time data analysis. Current solutions lack a comprehensive approach that combines these elements into a single, modular, and scalable unit.

### SUMMARY OF THE INVENTION

The invention provides a Remote AI Monitoring and Control Unit designed to overcome communication channel congestion, data loss, and delays. It integrates multiple communication protocols, advanced AI analysis, energy-efficient operation, and robust security measures.

### BRIEF DESCRIPTION OF DRAWINGS

FIG. 1: Block diagram of the Remote AI Monitoring and Control Unit.

FIG. 2: Flowchart illustrating the AI-based predictive maintenance process.

FIG. 3: Diagram showing the modular and scalable architecture of the unit.

FIG. 4: Schematic of the energy harvesting system integrated into the unit.

FIG. 5: Example of the AR interface displaying real-time data.

### DETAILED DESCRIPTION OF THE INVENTION

The present invention provides a Remote AI Monitoring and Control Unit designed to overcome communication channel congestion, data loss, and delays. The unit integrates multiple communication protocols, advanced AI analysis, energy-efficient operation, and robust security measures.

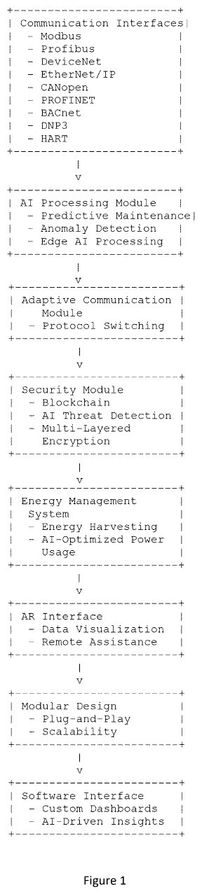

As shown in FIG. 1, the unit supports a wide range of communication protocols, including MQTT, USART, CAN bus, I2C, SPI, Modbus, Profibus, DeviceNet, EtherNet/IP, CANopen, PROFINET, BACnet, DNP3, and HART. This allows seamless interoperability with various industrial devices. The system can dynamically switch between protocols based on network conditions and operational requirements, optimizing performance and reliability.

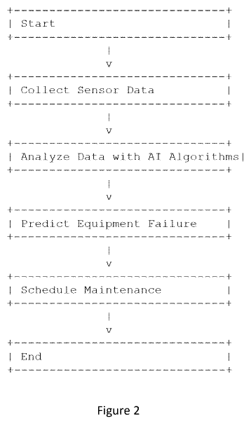

The unit features advanced AI capabilities, including predictive maintenance, anomaly detection, and edge AI processing. FIG. 2 illustrates the AI-based predictive maintenance process. AI algorithms analyze sensor data to predict equipment failures and schedule maintenance proactively. The unit continuously monitors data streams for unusual patterns, triggering alerts and automated responses to mitigate issues. Complex AI computations are performed locally on the device, reducing the need for constant cloud connectivity and ensuring faster response times.

Enhanced security is achieved through blockchain integration, AI-based threat detection, and multi-layered encryption. Data integrity is secured using blockchain technology, ensuring tamper-proof records. The system employs AI to detect and respond to cybersecurity threats in real-time. Data is protected with multiple layers of encryption both at rest and in transit.

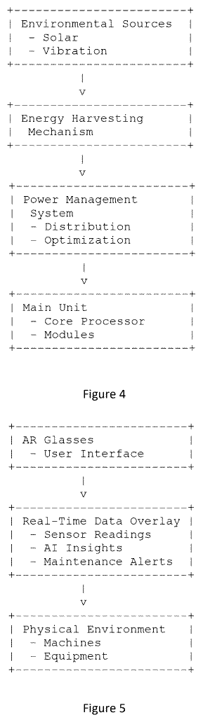

The unit incorporates energy-efficient operation with energy harvesting and AI-optimized power management. FIG. 4 shows the schematic of the energy harvesting system integrated into the unit. The unit can harvest energy from the environment (e.g., solar, vibration) to power itself, enhancing sustainability. AI optimizes power usage based on operational needs and environmental conditions, ensuring efficient energy consumption.

An augmented reality (AR) interface provides real-time data visualization and remote assistance. FIG. 5 provides an example of the AR interface displaying real-time data. AR technology overlays real-time data and analytics on the physical environment, enhancing user interaction. The system enables remote experts to provide assistance through AR, improving maintenance and troubleshooting processes.

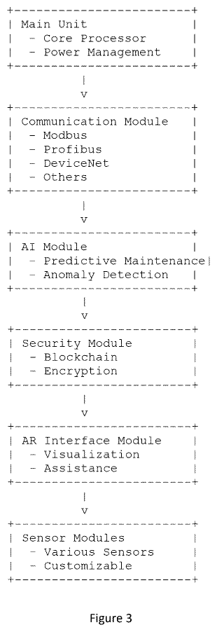

The modular and scalable design allows for easy customization and expansion. FIG. 3 depicts the modular and scalable architecture of the unit. The unit features interchangeable modules for different sensors, communication protocols, and AI capabilities, allowing for easy customization and expansion. It is designed to scale from small installations to large, complex networks without compromising performance.

The user-friendly software interface offers customizable dashboards and AI-driven insights. Users can create custom dashboards to display relevant data and controls tailored to their specific needs. The system provides actionable insights and recommendations generated by AI, simplifying decision-making processes.

1. A remote AI monitoring and control unit comprising:
One or more communication interfaces supporting a plurality of protocols including MQTT, USART, CAN bus, I2C, SPI, Modbus, Profibus, DeviceNet, EtherNet/IP, CANopen, PROFINET, BACnet, DNP3, and HART;
An AI processing module configured to perform predictive maintenance, anomaly detection, and real-time data analysis;
An adaptive communication module that dynamically switches between communication protocols based on network conditions;
A security module incorporating blockchain technology, AI-based threat detection, and multi-layered encryption;
An energy management system featuring energy harvesting and AI-optimized power usage;
An AR interface for real-time data visualization and remote assistance;
A modular design allowing for the addition or replacement of sensors, communication interfaces, and AI capabilities;
A user-friendly software interface with customizable dashboards and AI-driven insights.

2. The unit of claim 1, wherein the AI processing module is capable of performing edge AI processing.

3. The unit of claim 1, wherein the security module uses blockchain technology to secure data integrity.

4. The unit of claim 1, further comprising an energy harvesting mechanism to power the unit from environmental sources.

5. The unit of claim 1, wherein the AR interface provides an overlay of real-time data on the physical environment.

6. The unit of claim 1, wherein the modular design includes plug-and-play modules for various sensors and communication protocols.

7. The unit of claim 1, wherein the software interface allows users to customize dashboards and receive AI-generated insights and recommendations.

8. A remote AI monitoring and control unit as claimed in claim 1, further comprising an AI module for managing and optimizing communication protocols and AI tasks in real-time.

9. A remote monitoring and control unit comprising:
One or more communication interfaces supporting a plurality of protocols including MQTT, USART, CAN bus, I2C, SPI, Modbus, Profibus, DeviceNet, EtherNet/IP, CANopen, PROFINET, BACnet, DNP3, and HART;
A security module incorporating blockchain technology and multi-layered encryption;
An energy management system featuring energy harvesting;
A modular design allowing for the addition or replacement of sensors and communication interfaces;
A user-friendly software interface with customizable dashboards.
